(19) United States
(12) Patent Application Publication
(10) Pub. No.: US 2016/0195873 A1
(43) Pub. Date: Jul. 7, 2016

(54) PLANT MONITORING DEVICE

(71) Applicant: MITSUBISHI ELECTRIC CORPORATION, Chiyoda-ku, Tokyo (JP)

(72) Inventor: Kumiko TAKEGAWA, Tokyo (JP)

(73) Assignee: MITSUBISHI ELECTRIC CORPORATION, Chiyoda-ku, Tokyo (JP)

(21) Appl. No.: 14/911,427

(22) PCT Filed: Aug. 21, 2013
(86) PCT No.: PCT/JP2013/072286

§ 371 Date: Feb. 10, 2016

(51) Int. Cl. G05B 23/02

(52) U.S. Cl. CPC G05B 23/0232

(57) ABSTRACT

Visual noise removal processing means applies processing to suppress an influence of a fluctuation of a parameter given to an arrow to be displayed on a display device according to at least one of a changing trend of the parameter, a difference between the current value and the last value of the parameter, and the current value of the parameter. Consecutive appearances counting means counts the number of times a same changing trend appears consecutively in the parameter. Arrow highlight degree setting means increases a degree of highlight of the arrow as the number of times becomes larger.

### TECHNICAL FIELD

The present invention relates to a plant monitoring device to monitor parameters indicating a plant state.

### BACKGROUND ART

A plant monitoring device is used in a wide variety of fields in an atomic power plant, a chemical plant, a power receiving and distributing facility, a water supply sewerage system, and so on. An operator monitors various parameters indicating a plant state on the screen of the plant monitoring device to keep track of changing trends of these parameters, and takes an action to stabilize a parameter that is likely to deviate from criteria. In the case of an atomic power plant, for example, parameters include an output of a generator, an output of a reactor, a water level in the reactor, a pressure in the reactor, and so on.

A changing trend of a parameter is represented by an arrow in the related art as a measure aimed at reducing a burden on an operator who monitors parameters. For example, according to a process monitoring device proposed in PTL 1, a changing trend of input data is determined by a trend determination device and the changing trend is classified to no change, an uptrend (downtrend) at a constant rate, a sharp uptrend (downtrend) with plus acceleration, and a moderate uptrend (downtrend) with minus acceleration, each of which is represented by an arrow of a different shape.

Also, according to a plant state display method proposed in PTL 2, how close a parameter is to a limit value, whether the parameter is in an increasing or decreasing trend, and how much time is left until the parameter reaches the limit value are determined on the basis of data on each of a current value, a last value, and a limit value of an important parameter in the plant. An arrow in color and orientation corresponding to the determination result is displayed at the same time when the current value is displayed on a meter.

Also, according to a plant state display device proposed in PTL 3, an alert state is determined by comparing a plant state amount with multiple alert levels preliminarily set with changing rates. A display color of an arrow representing a change state of the plant state amount is changed according to the determined alert state.

### CITATION LIST

### Patent Literature

PTL 1: JP-A-1-287419

PTL 2: JP-A-58-189708

PTL 3: JP-A-61-101812

### SUMMARY OF INVENTION

### Technical Problem

Most of parameters indicating a plant state are determined as being abnormal when exceeding a pre-set allowable range. Meanwhile, a fluctuation that varies within the allowable range depending on an external condition, such as a temperature and a pressure, and an internal condition, such as reactivity, is observed even in a normal state. Such a fluctuation of a parameter is different from a variance of a parameter in an abnormal state, and does not require the operator to take any action.

In the methods of PTLs 1 through 3 in the related art as above, however, a changing trend is determined from an amount of change of a parameter including a fluctuation of the parameter in a normal state, and the determination result is displayed by an arrow. Accordingly, a direction and a color of the arrow are changed frequently, which appears as a visual noise and hence becomes a burden on the operator who monitors parameters.

The invention was devised to solve the problems discussed above and has an object to obtain a plant monitoring device capable of reducing a burden on an operator by suppressing a visual noise caused by a fluctuation of a parameter indicating a plant state when displaying a changing trend of the parameter by an arrow.

### Solution to Problem

A plant monitoring device of the invention is a plant monitoring device to monitor a parameter indicating a plant state. The parameter is determined as being abnormal when exceeding a pre-set allowable range and observed to undergo a fluctuation that varies within the allowable range even in a normal state. The plant monitoring device includes: display having a screen on which to display a changing trend of the parameter represented by an arrow; a processor to obtain current value of the parameter in predetermined cycles from a monitored plant facility, and to calculate a difference of the current value and a last value of the parameter, and to determine a changing trend of the parameter according to the difference between the current value and the last value of the parameter, and to apply visual noise removal processing which suppress an influence of the fluctuation of the parameter given to the arrow to be displayed on the display according to at least one of the changing trend of the parameter, the difference between the current value and the last value of the parameter, and the current value of the parameter, and to display the arrow processed in the visual noise removal processing on the display.

### Effect of Invention

The plant monitoring device of the invention includes a processor to apply visual noise removal processing which suppress an influence of a fluctuation of a parameter given to an arrow to be displayed on a screen of display, and therefore suppresses a visual noise, that is, frequent changes of the arrow due to a fluctuation of the parameter in a normal state. Hence, the plant monitoring device has an effect of reducing a burden on an operator who monitors parameters.

The foregoing and other objects, features, aspects, and effects of the invention will become more apparent from the following detailed description of the invention when taken in conjunction with the accompanying drawings.

### BRIEF DESCRIPTION OF DRAWINGS

FIG. 1 is a view showing a plant monitoring device according to a first embodiment of the invention.

FIG. 2 is a view showing a flow of parameter processing by plant monitoring devices according to first through fourth embodiments of the invention.

FIG. 3 is a view showing a flow of processing by visual noise removal processing means according to the first embodiment of the invention.

FIG. 4 is a view showing a flow of processing by visual noise removal processing means according to the second embodiment of the invention.

FIG. 5 is a view showing visual noise removal processing means according to the third embodiment of the invention.

FIG. 6 is a view showing a flow of processing by visual noise removal processing means according to the third embodiment of the invention.

FIG. 7 is a view showing visual noise removal processing means according to the fourth embodiment of the invention.

FIG. 8 is a view showing a flow of processing by visual noise removal processing means according to the fourth embodiment of the invention.

FIG. 9 is a view showing examples of arrows displayed by the plant monitoring devices according to the first through fourth embodiments of the invention.

### DESCRIPTION OF EMBODIMENTS

### First Embodiment

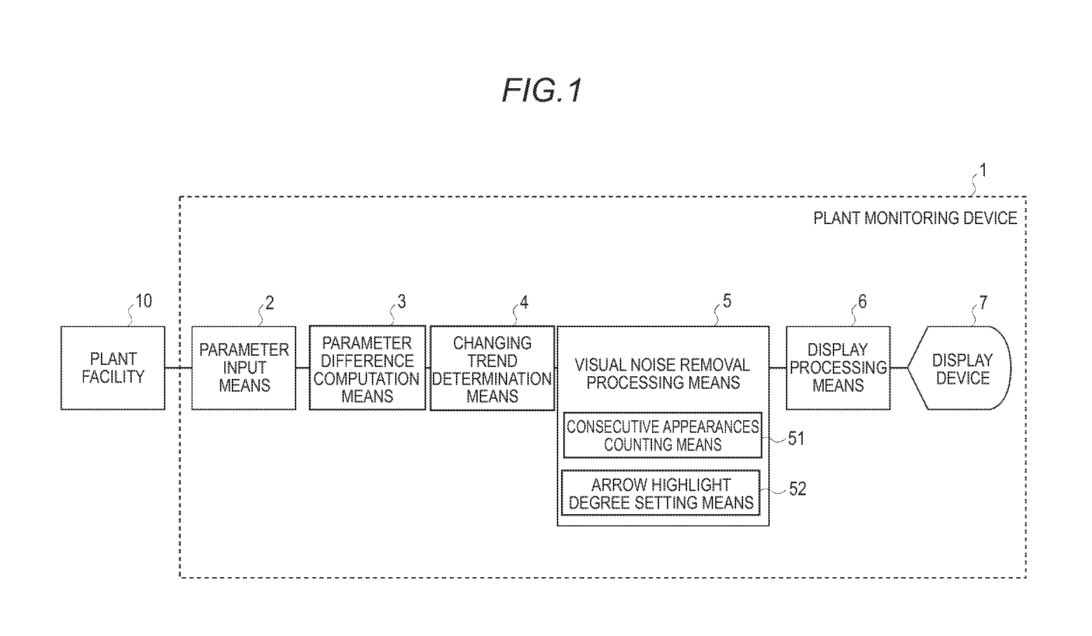

Hereinafter, a plant monitoring device according to a first embodiment of the invention will be described according to the drawings. FIG. 1 shows a configuration of the plant monitoring device of the first embodiment. The plant monitoring device 1 obtains various parameters indicating a plant state from a plant facility 10 including a control device, a measuring instrument, and so on to monitor current values and changing trends of the parameters.

In the case of an atomic power plant, for example, parameters indicating a plant state are an output of a generator, an output of an atomic reactor, a water level in the atomic reactor, a pressure in the atomic reactor, a radiation dose, and so on. Most of these parameters are determined as being abnormal when exceeding an allowable range preliminarily set for each parameter. Meanwhile, a fluctuation that varies within the allowable range depending on an external condition, such as a temperature and a pressure, and an internal condition, such as reactivity, is observed even in a normal state.

Parameter input means 2 obtains a current value of a parameter from the monitored plant facility 10 in predetermined cycles. The predetermined cycles are set for each parameter according to properties and importance of the parameter and can be changed according to situations, for example, whether it is a normal state or an abnormal state.

Parameter difference computation means 3 calculates a difference (amount of change) between the current value and the last value of each parameter obtained from the parameter input means 2. Changing trend determination means 4 determines a changing trend of the parameter according to a difference between the current value and the last value of the parameter obtained from the parameter difference computation means 3. More specifically, the changing trend determination means 4 determines that the parameter is in an increasing trend when the difference is plus, the parameter is in a decreasing trend when the difference is minus, and the parameter has not changed when the difference is zero.

In the first embodiment, a changing trend of a parameter is determined according to a difference between the current value and the last value of the parameter. However, a determination method of the changing trend is not limited to the method as above. For example, a method of calculating a difference between the current value and a reference value preliminarily set for each parameter, and determining a changing trend of the parameter according to the difference can be adopted as well.

Visual noise removal processing means 5 applies processing to suppress an influence of a fluctuation of the parameter given to an arrow to be displayed on a display device 7 according to at least one of the changing trend determined by the changing trend determination means 4, a difference between the current value and the last value of the parameter, and the current value of the parameter.

The visual noise removal processing means 5 of the first embodiment includes consecutive appearances counting means 51 and arrow highlight degree setting means 52. The consecutive appearances counting means 51 counts the number of times a same changing trend appears consecutively in a parameter. The arrow highlight degree setting means 52 determines whether to display an arrow according to the count result by the consecutive appearances counting means 51. When the arrow highlight degree setting means 52 determines to display an arrow, the arrow highlight degree setting means 52 sets an arrow at a degree of highlight which is increased as the number of times counted by the consecutive appearances counting means 51 becomes larger.

The arrow highlight degree setting means 52 changes a degree of highlight of the arrow step by step by changing at least one of shading of a display color, a type of the display color, and a size of the arrow. For example, when black is a background color of the screen of the display device 7, a degree of highlight is increased as shading of the display color of the arrow becomes lighter (for example, white>light grey>grey>dark grey).

Generally, it is seldom that a same changing trend appears consecutively in a fluctuation of a parameter in a normal state. Even when the same changing trend does appear consecutively, the number of consecutive appearances is small. On the other hand, a same changing trend often appears consecutively in an abnormal state, such as in the event of an accident. Hence, according to the processing as above, an arrow at a low degree of highlight is set for a changing trend due to a fluctuation of the parameter and an arrow at a high degree of highlight is set for a changing trend in an abnormal state.

Display processing means 6 performs processing to display the arrow processed in the visual noise removal processing means 5 on the display device 7. More specifically, the display processing means 6 selects an up-pointing arrow when the changing trend determined by the changing trend determination means 4 is an increasing trend and a down-pointing arrow when the determined changing trend is a decreasing trend, and displays the selected arrow at a degree of highlight set by the visual noise removal processing means 5. It should be noted that no arrow is displayed when the parameter has not changed. A shape and an upward or downward angle of the arrow are not particularly limited and can be set arbitrarily.

Although it is not shown in FIG. 1, the plant monitoring device 1 includes an input device, such as a mouse, a keyboard, and a touch device, with which an operator makes an operation, and storage means for storing input parameters and a computation result.

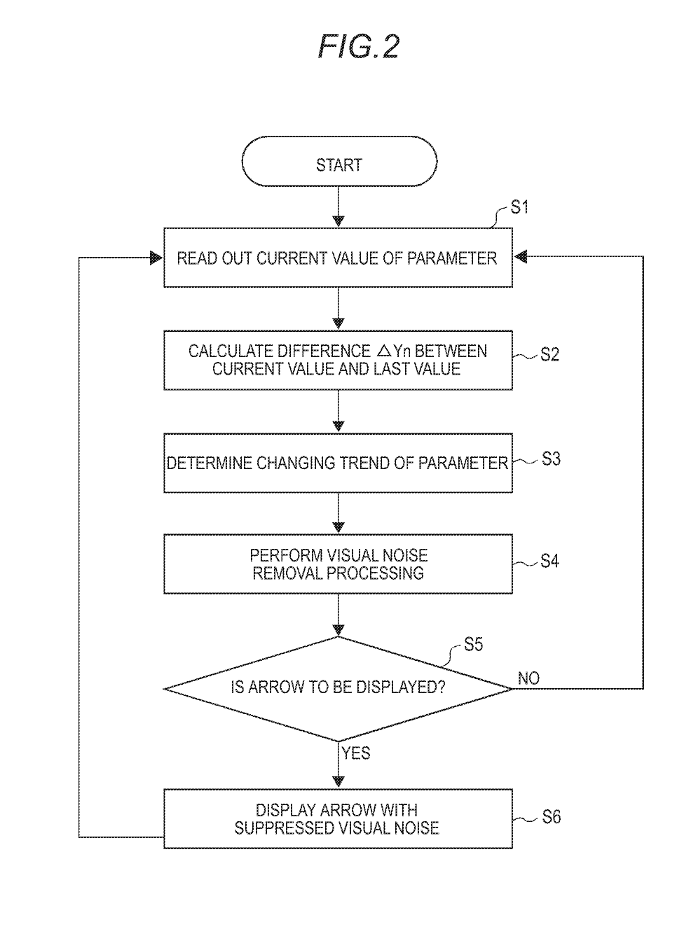

A flow of parameter processing by the plant monitoring device 1 will now be described using the flowchart of FIG. 2. The flowchart of FIG. 2 depicts a flow of the processing common in the first through fourth embodiments of the invention. In Step 1 (S1) first, the parameter input means 2 reads out a current value Yₙ of a parameter from the plant facility 10. In subsequent Step 2 (S2), the parameter difference computation means 3 calculates a difference ΔYₙ between the current value Yₙ and the last value Yₙ₋₁ of the parameter (ΔYₙ=Yₙ−Yₙ₋₁).

In subsequent Step 3 (S3), the changing trend determination means 4 determines a changing trend of the parameter according to the difference ΔYₙ found in S2. When ΔYₙ>0, the changing trend determination means 4 determines that the changing trend is an increasing trend, and when ΔYₙ<0, the changing trend determination means 4 determines that the changing trend is a decreasing trend. When ΔYₙ=0, the changing trend determination means 4 determines that the parameter has not changed.

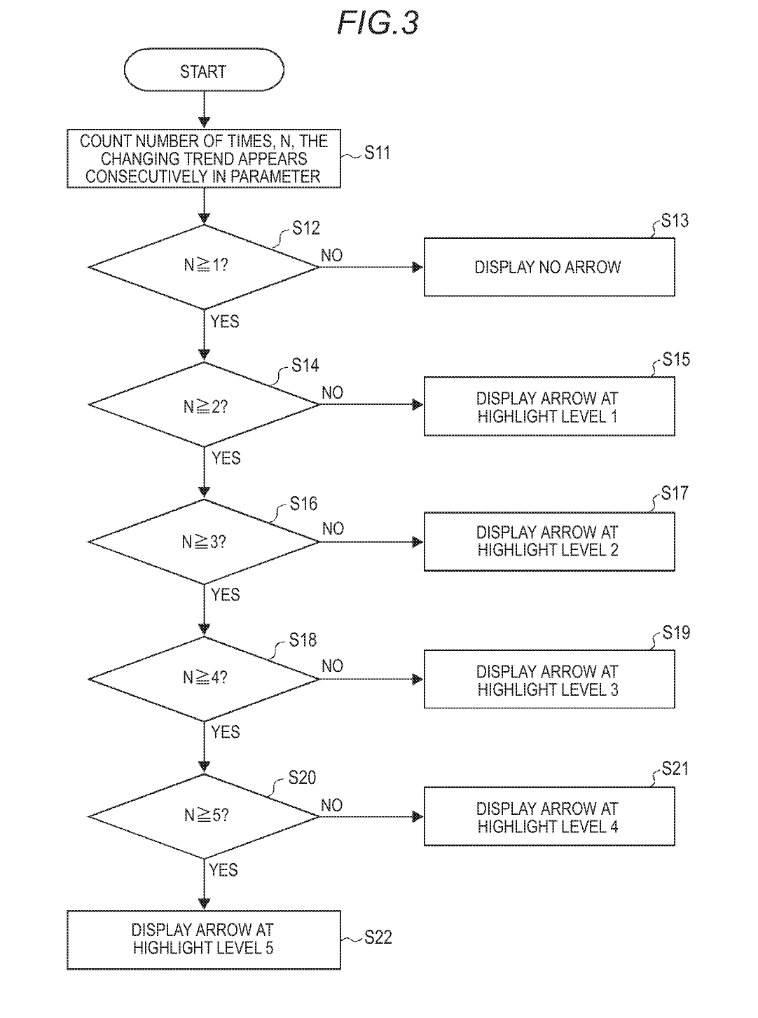

In subsequent Step 4 (S4), the visual noise removal processing means 5 applies the visual noise removal processing to an arrow to be displayed on the display device 7 in order to suppress an influence of a fluctuation of the parameter. The visual noise removal processing in the first embodiment will be described in detail below using the flowchart of FIG. 3.

In subsequent Step 5 (S5), the visual noise removal processing means 5 determines whether to display an arrow on the display device 7 according to the processing result in S4. When the visual noise removal processing means 5 determines not to display an arrow (NO), the flow returns to S1. When the visual noise removal processing means 5 determines to display an arrow (YES), the visual noise removal processing means 5 displays an arrow with which a visual noise is suppressed in S4. Subsequently, the flow returns to S1. In this manner, the processing in one loop ends.

The visual noise removal processing by the visual noise removal processing means 5 of the first embodiment will now be described in detail using the flowchart of FIG. 3. In FIG. 3, degrees of highlight are classified to five levels (level 1<level 2<level 3<level 4<level 5). It should be appreciated, however, that the number of highlight levels can be changed arbitrarily. The visual noise removal processing means 5 of the first embodiment performs processing according to the count result by the consecutive appearances counting means 51, that is, sets a color flag of an arrow at a highlight level according to the number of consecutive appearances.

In Step 11 (S11) first, the consecutive appearances counting means 51 obtains a changing trend of the parameter from the changing trend determination means 4 and counts the number of times, N, the same changing trend appears consecutively.

In subsequent Step 12 (S12), whether N≧1 is determined. When N≧1 (YES), advancement is made to Step 14 (S14). When N<1 (NO) in S12, the number of consecutive appearances is determined to be 0. Hence, it is determined “not to display an arrow” in Step 13 (S13).

In subsequent S14, whether N≧2 is determined. When N≧2 (YES), advancement is made to Step 16 (S16). When N<2 (NO) in S14, the number of consecutive appearances is determined to be one. Hence, a flag color of an arrow at the highlight level 1 is set in Step 15 (S15).

In subsequent S16, whether N≧3 is determined. When N≧3 (YES), advancement is made to Step 18 (S18). When N<3 (NO) in S16, the number of consecutive appearances is determined to be two. Hence, a color flag of an arrow at the highlight level 2 is set in Step 17 (S17).

In subsequent S18, whether N≧4 is determined. When N≧4 (YES), advancement is made to Step 20 (S20). When N<4 (NO) in S18, the number of consecutive appearances is determined to be three. Hence, a color flag of an arrow at the highlight level 3 is set in Step 19 (S19).

In subsequent S20, whether N≧5 is determined. When N<5 (NO), the number of consecutive appearances is determined to be four. Hence, a color flag of an arrow at the highlight level 4 is set in Step 21 (S21). When N≧5 (YES) in S20, the number of consecutive appearances is determined to be five or more. Hence, a color flag of an arrow at the highlight level 5 is set in Step 22 (S22).

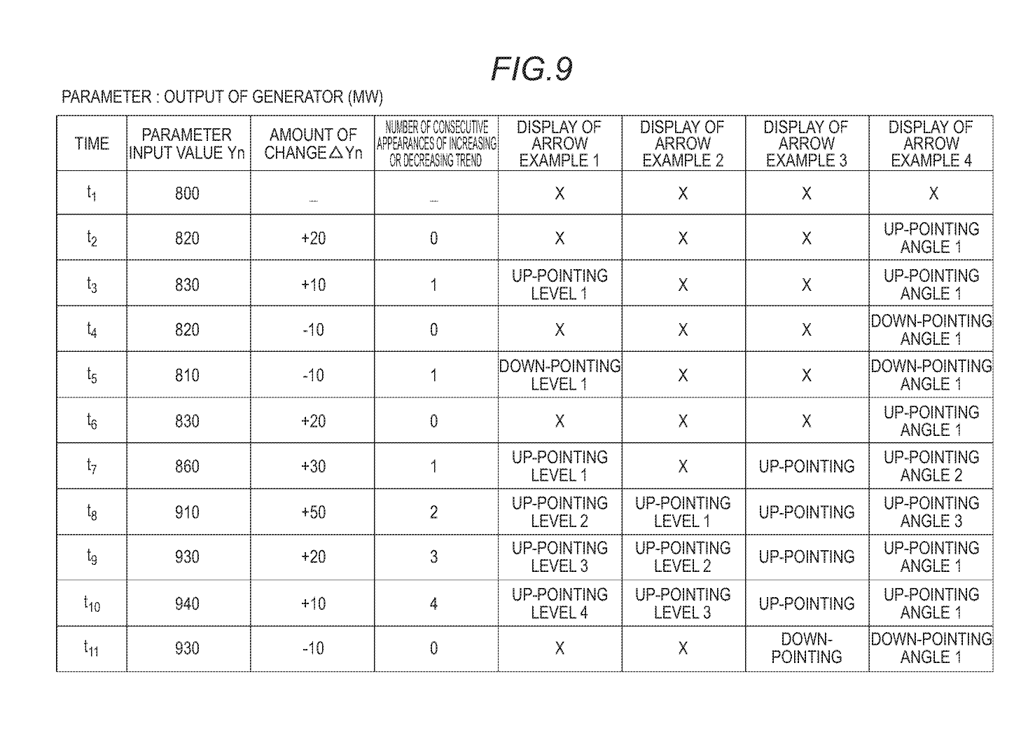

As has been described, according to the plant monitoring device 1 of the first embodiment, owing to the visual noise removal processing means 5, an arrow is displayed at a higher degree of highlight as the same changing trend appears a larger number of times consecutively in a parameter, whereas no arrow is displayed when the same changing trend does not appear consecutively. Consequently, the number of times the arrow is displayed can be reduced and hence a visual noise can be suppressed (see Example 1 of FIG. 9).

In particular, a changing trend due to a fluctuation of a parameter seldom shows a continuous increase or decrease. Hence, the display of an arrow due to the fluctuation can be suppressed, and a burden on the operator who monitors parameters can be reduced. In addition, because a changing trend is found from a difference between the current value and the last value of a parameter, the changing trend can be displayed by an arrow without a time lag.

### Second Embodiment

An overall configuration of a plant monitoring device according to a second embodiment of the invention is the same as the counterpart of the first embodiment above, and a description is omitted herein (see FIG. 1). Visual noise removal processing means 5 in the plant monitoring device 1 of the second embodiment includes consecutive appearances counting means 51 and arrow highlight degree setting means 52 as the counterpart in the first embodiment above.

In the first embodiment above, the arrow highlight degree setting means 52 sets an arrow at a higher degree of highlight as the number of consecutive appearances counted by the consecutive appearances counting means 51 becomes larger while no arrow is displayed when the same changing trend does not appear consecutively. However, an arrow is displayed even when the number of consecutive appearances is small.

The second embodiment takes this configuration into consideration, and in order to further suppress a visual noise due to a fluctuation of a parameter in a normal state, the arrow highlight degree setting means 52 performs processing not to display an arrow when the number of consecutive appearances counted by the consecutive appearances counting means 51 is equal to or less than a pre-set allowable number of times. The allowable number of times is preliminarily set for each parameter and can be changed later.

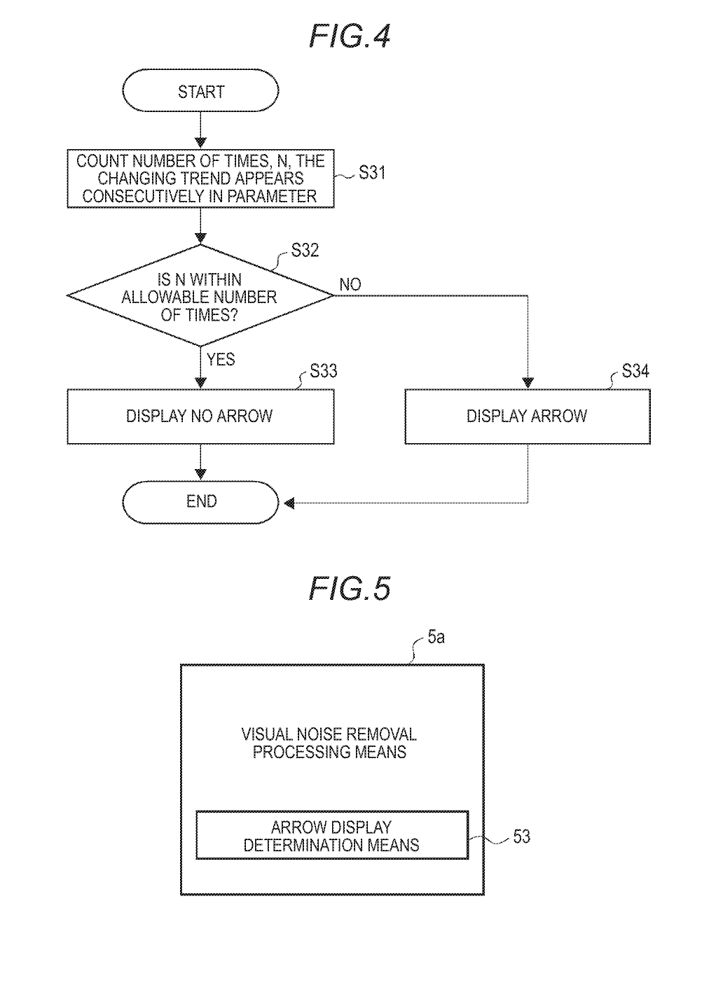

FIG. 4 shows a flowchart depicting a flow of visual noise removal processing of the second embodiment. In Step 31 (S31), the consecutive appearances counting means 51 in the visual noise removal processing means 5 obtains a changing trend of a parameter from changing trend determination means 4 and counts the number of times, N, the same changing trend appears consecutively.

In subsequent Step 32 (S32), the arrow highlight degree setting means 52 determines whether the number of times, N, counted in S31 is within the allowable number of times. When the number of times, N, is within the allowable number of times (YES) in S32, advancement is made to Step 33 (S33) in which it is determined not to display an arrow. When the number of times, N, exceeds the allowable number of times (NO) in S32, advancement is made to Step 34 (S34) in which it is determined to display an arrow. When an arrow is displayed in S34, a degree of highlight of the arrow is increased as the number of consecutive appearances becomes larger in the same manner as in the first embodiment above.

According to the second embodiment, an arrow is not displayed when the number of consecutive appearances is equal to or less than the allowable number of times. Hence, the number of times the arrow is displayed can be reduced further in comparison with the first embodiment above. Consequently, a visual noise can be suppressed (see Example 2 of FIG. 9).

### Third Embodiment

An overall configuration of a plant monitoring device according to a third embodiment of the invention is the same as the counterpart of the first embodiment above, and a description is omitted herein (see FIG. 1). As shown in FIG. 5, visual noise removal processing means 5a in the plant monitoring device of the third embodiment includes arrow display determination means 53 for determining whether to display an arrow according to at least one of the current value of a parameter and a difference (amount of change) between the current value and the last value of the parameter.

The arrow display determination means 53 obtains the current value of a parameter from the parameter input means 2 and performs processing not to display an arrow when the current value of the parameter is within a pre-set allowable range. The allowable range is preliminarily set for each parameter and can be changed later.

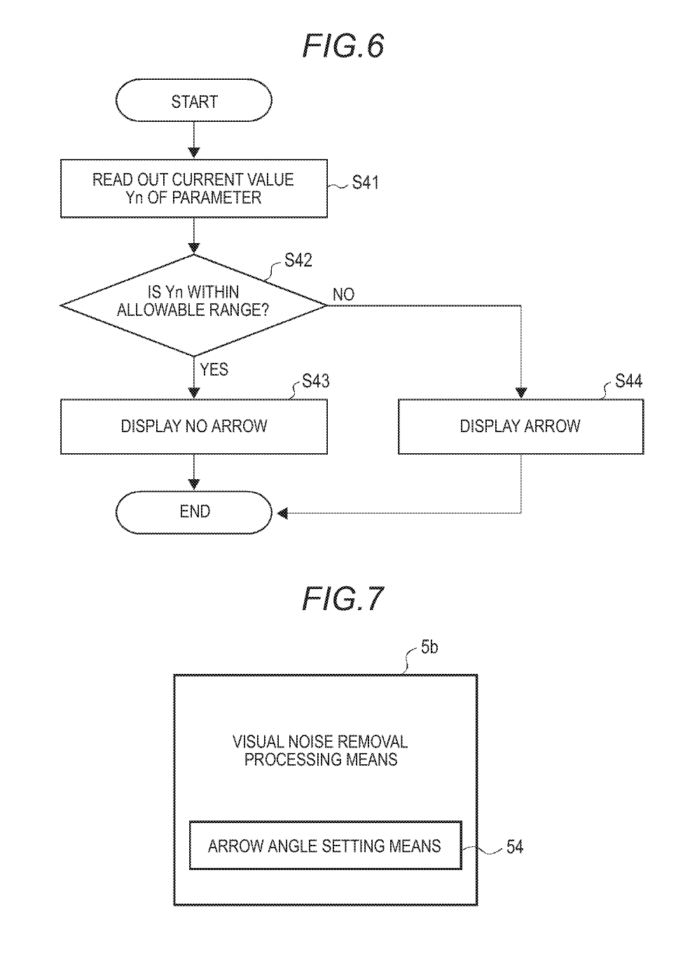

FIG. 6 is a flowchart depicting a flow of processing by the visual noise removal processing means 5a of the third embodiment. In Step 41 (S41), the arrow display determination means 53 in the visual noise removal processing means 5a reads out the current value Yₙ of the parameter from the parameter input means 2.

In subsequent Step 42 (S42), whether the current value Yₙ of the parameter obtained in S41 is within the allowable range is determined. When the current value Yₙ of the parameter is within the allowable range (YES) in S42, advancement is made to Step 43 (S43) in which it is determined not to display an arrow. When the current value Yₙ of the parameter is out of the allowable range (NO) in S42, advancement is made to Step (S44) in which it is determined to display an arrow. Accordingly, an arrow according to the determination result by the changing trend determination means 4 is displayed.

Alternatively, the arrow display determination means 53 may determine whether to display an arrow on the basis of an amount of change of the parameter. In this case, the arrow display determination means 53 obtains a difference between the current value and the last value, that is, an amount of change, of the parameter from parameter difference computation means 3. When the amount of change is equal to or less than a pre-set allowable amount of change, the processing not to display an arrow is performed. The allowable amount of change is preliminarily set for each parameter and can be changed later.

Further, the arrow display determination means 53 may determine whether to display an arrow according to both of the current value and an amount of change of a parameter.

An allowable range of the current value of a parameter is set according to a mean value μ or a deviation σ of the parameter. For example, an example of the allowable range of a parameter can be expressed as: μ−σ<Yₙ<μ+σ. Also, an example of the allowable amount of change of a parameter can be expressed as: −σ<ΔYₙ<σ.

Furthermore, the arrow display determination means 53 may calculate a difference between a “reference value” preliminarily set for each parameter and the current value of a parameter of interest to perform the processing not to display an arrow when the calculated difference is within the allowable range.

The visual noise removal processing means 5a of the third embodiment may be provided with the consecutive appearances counting means 51 and the arrow highlight degree setting means 52 in the first embodiment or the second embodiment above. In this case, whether to display an arrow or not is determined according to the determination results by the consecutive appearances counting means 51 and the arrow display determination means 53. When it is determined to display an arrow, an arrow is displayed at a degree of highlight corresponding to the number of consecutive appearances.

According to the third embodiment, an arrow is not displayed when the current value (or an amount of change) of the parameter is within the pre-set allowable range (or equal to or less than an allowable amount of change). Consequently, the number of times the arrow is displayed can be reduced and hence the visual noise can be suppressed (see Example 3 of FIG. 9). In particular, because an amount of change due to a fluctuation of the parameter is small, the display of the arrow due to a fluctuation can be suppressed.

### Fourth Embodiment

An overall configuration of a plant monitoring device according to a fourth embodiment of the invention is the same as the counterpart of the first embodiment above, and a description is omitted herein (see FIG. 1). As is shown in FIG. 7, visual noise removal processing means 5b of the fourth embodiment includes arrow angle setting means 54 for setting an angle of an axis of an arrow with respect to a horizontal direction according to a difference between the current value and the last value of the parameter in such a manner that the angle is increased as an amount of change of the parameter becomes larger.

The arrow angle setting means 54 sets angles of the axis of an arrow between the horizontal direction and a perpendicular direction in multiple steps, for example, three steps. When a changing trend is an increasing trend, the axis of the arrow has an upward angle with respect to the horizontal direction. When the changing trend is a decreasing trend, the axis of the arrow has a downward angle with respect to the horizontal direction. In addition, an angle becomes larger as an amount of change becomes larger.

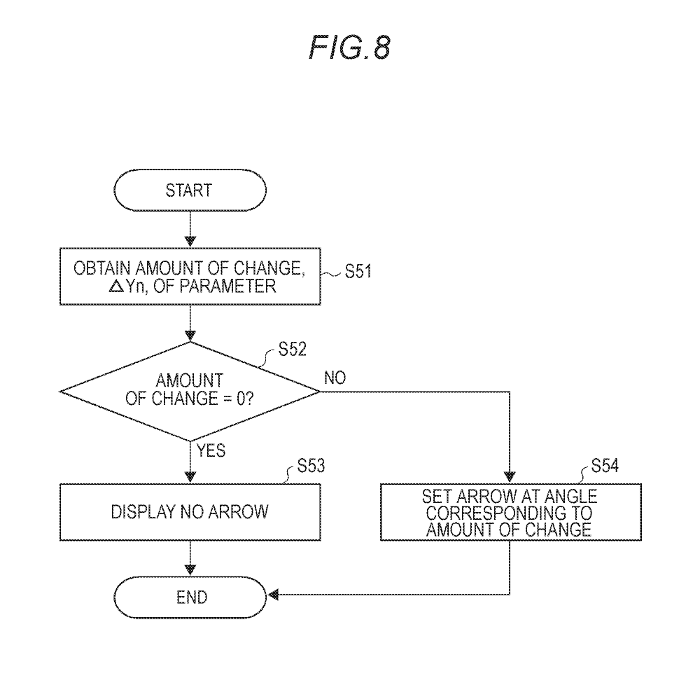

FIG. 8 shows a flowchart depicting a flow of processing by the visual noise removal processing means 5b of the fourth embodiment. In Step 51 (S51), the arrow angle setting means 54 in the visual noise removal processing means 5b obtains an amount of change, ΔYₙ, of the parameter from parameter difference computation means 3.

In subsequent Step 52 (S52), whether the amount of change, ΔYₙ, of the parameter obtained in S51 is 0 is determined. When ΔYₙ=0 (YES) in S52, advancement is made to Step 53 (S53) in which it is determined not to display an arrow. When ΔYₙ≠0 (NO) in S52, it is determined in Step 54 (S54) to display an arrow and an angle corresponding to the amount of change is set to the arrow.

The visual noise removal processing means 5b in the fourth embodiment may be provided with the consecutive appearances counting means 51 and the arrow highlight degree setting means 52 of the first embodiment or the second embodiment above. In addition to this combination, the arrow display determination means 53 of the third embodiment above may be provided further.

According to the fourth embodiment, an arrow at an angle corresponding to an amount of change of the parameter is displayed. Hence, an operator can know from the angle of the arrow whether an amount of change of the parameter is large or small. A burden of the operator can be therefore reduced. In addition, by performing the processing not to display an arrow at a small angle or display an arrow at a small angle by an arrow at a relatively low degree of highlight, a visual noise due to a fluctuation of the parameter can be suppressed.

In the plant monitoring devices 1 of the first through third embodiments above and the fourth embodiment, the visual noise removal processing was applied to an arrow representing a changing trend of a parameter which was an output of a generator (MW) in a power generation plant, and the result is shown in FIG. 9.

In FIG. 9, Example 1 is a case where the visual noise removal processing means 5 of the first embodiment above performed processing to display an arrow at a higher degree of highlight as the same trend appears a larger number of times consecutively. Herein, four highlight levels are set as: level 1<level 2<level 3<level 4. In Example 1, an arrow is displayed when the number of consecutive appearances is one or more.

Example 2 is a case where the visual noise removal processing means 5 of the second embodiment above performed processing to display an arrow at a degree of highlight corresponding to the number of consecutive appearances by setting an allowable value of the number of consecutive appearances to one. In Example 2, an arrow is not displayed when the number of consecutive appearances is one. An arrow at the level 1 is displayed when the number of consecutive appearances is two and an arrow at the level 2 is displayed when the number of consecutive appearances is three. Accordingly, the number of times the arrow is displayed is reduced in comparison with Example 1 above.

Example 3 is a case where the visual noise removal processing means 5a of the third embodiment above performed processing not to display an arrow when the parameter input value (current value) was within an allowable range set from 800 MW to 850 MW. According to this processing method, by broadening the allowable range, the number of times the arrow is displayed can be reduced further.

Example 4 is a case where the visual noise removal processing means 5b of the fourth embodiment set an angle corresponding to an amount of change, ΔYₙ, of the parameter to the arrow. Herein, angles are set in three steps as: angle 1<angle 2<and angle 3. When |ΔYₙ|≦20, the angle 1 is set. When 20<|ΔYₙ|≦40, the angel 2 is set. When |ΔYₙ|>40, the angle 3 is set.

In Example 4, whether an amount of change of the parameter is large or small can be known from the angle of the arrow. Also, by adopting the determination as to whether to display an arrow or not in any of Examples 1 through 3 in Example 4, not only can the number of times the arrow is displayed be reduced, but also whether an amount of change of the parameter is large or small can be known.

The processing by the visual noise removal processing means 5, 5a, and 5b in the first through third embodiments above and the fourth embodiment can be combined as needed, and when combined, a further higher visual noise removing effect can be obtained. The respective embodiments of the invention can be combined without any restriction and the respective embodiments can be modified or omitted as need within the scope of the invention.

### INDUSTRIAL APPLICABILITY

The invention can be used as a plant monitoring device to monitor a plant state.

1. A plant monitoring device to monitor a parameter which indicates a plant state and is determined as being abnormal when exceeding a pre-set allowable range and observed to undergo a fluctuation that varies within the allowable range even in a normal state, the plant monitoring device comprising:
a display having a screen on which to display a changing trend of the parameter represented by an arrow;
a processor to obtain a current value of the parameter in predetermined cycles from a monitored plant facility,
and to calculate a difference of the current value and a last value of the parameter,
and to determine a changing trend of the parameter according to the difference between the current value and the last value of the parameter,
and to apply visual noise removal processing to suppress an influence of the fluctuation of the parameter given to the arrow to be displayed on the display according to at least one of the changing trend of the parameter, the difference between the current value and the last value of the parameter, and the current value of the parameter, and
to display the arrow processed the visual noise removal processing on the display means.

2. The plant monitoring device according to claim 1, wherein:
the visual noise removal processing
counts the number of times a same changing trend appears consecutively in the parameter, and
determining determines whether to display the arrow according to a count result, and processes arrow highlight degree setting which sets an arrow with a higher degree of highlight as the number of times becomes larger when the arrow is displayed.

3. The plant monitoring device according to claim 2, wherein:
the arrow highlight degree setting changes a degree of highlight of the arrow step by step by changing at least one of shading of a display color, a type of the display color, a size of the arrow.

4. The plant monitoring device according to claim 2, wherein:
the arrow highlight degree setting does not display the arrow when the number of times the same changing trend appears consecutively in the parameter is equal to or less than a pre-set allowable number of times.

5. The plant monitoring device according to claim 1, wherein:
the visual noise removal processing means does not display the arrow when the current value of the parameter is within the allowable range.

6. The plant monitoring device according to claim 1, wherein:
the visual noise removal processing does not display the arrow when a difference between the current value and the last value of the parameter is equal to or less than a pre-set allowable amount of change.

7. The plant monitoring device according to claim 1, wherein:
the visual noise removal processing increases an angle of an axis of the arrow with respect to a horizontal direction as a difference between the current value and the last value of the parameter becomes larger.
